(19) United States
(12) Patent Application Publication
(10) Pub. No.: US 2026/0187902 A1
(43) Pub. Date: Jul. 2, 2026

(54) METHOD AND SYSTEM FOR GENERATING AN EDITED 3D TEXTURE IMAGE

(71) Applicant: HUAWEI TECHNOLOGIES CO., LTD., Shenzhen (CN)

(72) Inventors: Yanhui GUO, Kanata (CA); Xinxin ZUO, Kanata (CA); Peng DAI, Kanata (CA); Juwei LU, Kanata (CA); Xiaofei WU, Shenzhen (CN); Youliang YAN, Shenzhen (CN)

(21) Appl. No.: 19/547,006

(22) Filed: Feb. 23, 2026

Related U.S. Application Data
(63) Continuation of application No. PCT/CN2023/120219, filed on Sep. 21, 2023.

(51) Int. Cl. G06T 15/04; G06T 17/20; G06T 19/20

(52) U.S. Cl. CPC G06T 15/04; G06T 17/20; G06T 19/20; G06T 2219/2012

(57) ABSTRACT

The present invention relates to generating at least one 3D texture image, said method comprising acquiring a first plurality of multi-view images of an object; generating a 3D mesh of said object from said first plurality of multi-view images; calculating a UV atlas; generating: one diffuse UV texture using a first multilayer perceptron MLPd, and one specular color image using a second multilayer perceptron MLPs; generating one diffuse color image by rendering said diffuse UV texture combined with said 3D mesh; rendering at least a 3D texture image by combining said specular color image with said diffuse color image; editing one image; propagating said editing onto said diffuse UV texture; generating an edited diffuse color image by rendering said edited diffuse UV texture combined with said 3D mesh; and rendering an edited 3D texture image by combining said specular color image with said edited diffuse color image.

### CROSS-REFERENCE TO RELATED APPLICATIONS

The present patent application is a continuation application of the International Patent Application No. PCT/CN2023/120219 filed on Sep. 21, 2023, the entirety of which is incorporated herein by reference.

### TECHNICAL FIELD

The present technology relates to 3D digital content generation, and more specifically to methods and systems for generating editable 3D texture image.

### BACKGROUND

In recent years, Neural Radiance Fields (NeRF) have gained popularity for its impressive ability to reconstruct and render large-scale scenes with realistic details. However, NeRF representations often use implicit functions and specialized ray marching algorithms for rendering, making them difficult to manipulate and slow to render due to poor hardware support, which limits their use in downstream applications.

On the other hand, 3D models represented as triangle meshes can be rendered at real-time frame rates on commodity devices. And with some 3D modeling techniques, such as DenseMVS, MVSNet and NeuS, it could be possible to get reasonable 3D geometry. Now the critical part is to bind textures for those generated meshes to achieve comparable photo-realistic rendering results as NeRF.

There are some texture mapping and optimization approaches that optimize the patches from the captured multi-view images to form a seamless UV texture map. But they only consider a global texture without any view-dependent effects.

Prior methods of optimizing neural textures cannot support direct user editing without re-training the network.

There are other works on baking the view-dependent UV textures from the NeRF (see for example the following publication: “Mildenhall et al. NeRF: Representing Scenes as Neural Radiance Fields for View Synthesis, 2020”). For example, some prior art models the scene with a geometry grid together with an appearance grid (see for example the following publication: “Tang et al. Delicate Textured Mesh Recovery from NeRF via Adaptive Surface Refinement, 2023”). The view-dependent texture is optimized in the appearance grid not directly in the UV space, so the pipeline cannot be directly deployed to meshes output by other methods or tools.

Therefore, the current texture mapping approaches are either not view-dependent which used a single global texture image, or the texture extraction process was fully entangled with the NeRF model which made it not adaptable to mesh exportation by other tools or methods.

There is a need for ameliorating these techniques and for developing an innovative technology to solve these technical issues.

### SUMMARY

The present technology has been designed to overcome at least some drawbacks present in prior art solutions.

According to an embodiment, the present invention relates to a method and a system to allow editing 3d texture image.

The present invention relates to a method for generating at least one edited 3D texture image, said method being configured to be executed by at least one computer-implemented system, said method comprising:
Acquiring a first plurality of multi-view images of an object;
Generating a 3D mesh of said object from said first plurality of multi-view images;
Calculating a UV atlas from said 3D mesh, said UV atlas comprising UV coordinates which maps vertices on said 3D mesh onto at least one UV image;
Generating:
   a diffuse UV texture using a first multilayer perceptron MLPd configured to process said UV coordinates;
   a specular color image using a second multilayer perceptron MLPs configured to process said directions;
Generating a diffuse color image by rendering said diffuse UV texture combined with said 3D mesh;
Rendering a 3D texture image by combining said specular color image with said diffuse color image;
Editing, by a user, at least one image of said first plurality of multi-view images and/or at least one image rendered from said 3D texture image;
Propagating said editing onto said diffuse UV texture;
Generating an edited diffuse color image by rendering said edited diffuse UV texture combined with said 3D mesh;
Rendering an edited 3D texture image by combining said specular color image with said edited diffuse color image.

The present invention allows to generate textures for 3D triangle meshes that supports view-dependent rendering and advantageously 3D consistent user-friendly editing with the view-dependent effects still maintained in the edited part. The present invention can be compatible with meshes output from existing 3D modeling techniques.

According to an embodiment, the input of the present invention is a reconstructed 3D triangle mesh, and captured multi-view images of the object. The 3D triangle mesh could be restored from either NeRF related methods such as NeuS or MVS related methods. The present invention allows to bind view-dependent neural texture to the 3D triangle mesh to support real-time on-device high fidelity novel view rendering.

According to an embodiment, the output of the present invention can be rendered at real-time frame rates on commodity devices. The present invention allows a real-time rendering that outperforms prior work in terms of realism, speed. The present invention allows to reduce the power consumption to reach these performances. Furthermore, the present invention supports convenient user editing on the images and, advantageously maintains 3D consistent and view-dependent editing.

According to an embodiment, the present invention is configured to support interactive texture editing. For specifically, a user can edit 2D images interactively and with the present invention, the user editing can be propagated back into 3D texture. More importantly, the edited part is configured to still have the view-dependent effect which is consistent with original input images.

Advantageously, the present invention can be deployed in real world for 3D model reconstruction and generations applications.

According to an embodiment, a user can capture multi-view images with his smartphone or other image capturing device. Then, the present invention is configured to generate view-dependent textured meshes. The mesh can be displayed in general laptop or smartphones, and the rendered objects can be viewed in novel views with view-dependent and photo-realistic rendering results.

The user can edit on any view of 2D image, and the user scribbles, mark or editing are propagated into 3D texture and rendered into any novel views, with the view-dependent effects maintained. This feature can be integrated and implemented into 3D texture interactive editing tools.

The present invention allows provides photo-realistic view-dependent rendering effects.

The present invention is compatible with existing computer generated (CG) rendering pipeline.

The present invention supports user-friendly editing with view-dependent effects automatically maintained.

The present invention works with 3D meshes output by any 3D modeling tools or approaches and is independent of mesh reconstruction processes.

The present invention also relates to a computer product program generating at least one 3D texture image which, when executed by at least one computer-implemented system, executes the method according to the present invention.

The present invention also relates to a non-volatile memory comprising at least one computer program product according to the present invention.

The present invention also relates to a computer-implemented system for generating at least one 3D texture image comprising at least:
An acquiring module configured to acquire at least a first plurality of multi-view images of an object;
A 3D mesh generating module configured to generate at least a 3D mesh from said first plurality of multi-view images;
A processing module configured to calculate at least one atlas from said 3D mesh;
A first multilayer perceptron module configured to generate at least one specular color image using a first multilayer perceptron MLPs configured to process said directions;
A second multilayer perceptron module configured to generate at least one diffuse UV texture using a second multilayer perceptron MLPd configured to process said UV coordinates;
A UV texture generating module configured to generate at least one diffuse color image by rendering said diffuse UV texture combined with said 3D mesh;
A 3D texture image generating module configured to render at least a 3D texture image by combining at least said specular color image with said diffuse color image;
An editing module configured to allow at least one user to edit at least one image from said first plurality of multi-view images and/or at least one image rendered from said 3D texture image.

The present invention also relates to an editable view-dependent rendering engine comprising at least one computer-implemented system according to the present invention configured to implement a method according to the present invention.

According to an example, said representation of said 3D object is reconstructed from at least a plurality of images of an object.

According to an example, said 3D mesh is a 3D triangle mesh.

According to an example, a correspondence between UV image and every image pixel of said UV texture image is pre-computed to generate at least one mapping, said mapping being cached in at least one memory. Advantageously, said cached mapping can be used to train a network, and since said mapping will not change, this avoids recomputing it every training iterations.

According to an example, said step of acquiring said first plurality of view dependent of said object comprises:
capturing a plurality of images of said object; and/or
downloading a plurality of images of said object from at least one database.

According to an example, said step of generating said diffuse UV texture comprises:
Positional encoding of said 2D UV coordinates;
Generating at least one feature fs using at least said first multilayer perceptron MLPd, said feature fs being configured to be used to generate said specular color image;
Generating said diffuse UV texture by processing said positional encoded 2D UV coordinates by at least said first multilayer perceptron MLPd.

According to an example, said step of generating said specular color image comprises:
Positional encoding of said view direction;
Concatenating at least said positional encoded view direction with at least said feature fₛ;
Generating at least one specular UV texture by processing said concatenation by at least said second multilayer perceptron MLPs;
Converting said specular UV texture into a specular color image.

According to an example, said step of generating at least one diffuse UV texture comprises:
Encoding of each UV coordinate with at least a predetermined number of channels of features;
Generating at least one diffuse UV texture and at least one feature vector using at least one third multilayer perceptron MLPdf configured to process said features.

According to an example, said step of generating at least one specular color image comprises:
Positional encoding of said view direction;
Concatenating said feature vector with at least said positional encoded view direction;
Generating said specular UV texture by processing said concatenation by at least a fourth multilayer perceptron MLPsf;
Converting said specular UV texture into said specular color image.

According to an example, said step of generating said diffuse color image comprises rendering said diffuse UV texture into a diffuse color image.

According to an example, said step of generating said diffuse color image comprises converting said diffuse UV texture from a UV space into a color space to generate said diffuse color image.

According to an example, said step of editing comprises:
Selecting at least one 2D image among said first plurality of multi-view images and/or at least one 2D image from said 3D texture image;
Modifying locally at least a region of said 2D image, for example by changing the RBG value of a set of points of said region.

According to an example, said step of propagating said editing onto said diffuse UV texture comprises:
Localizing said edited region in said 2D image as a masked region;
Rendering said UV texture onto corresponding 2D image;
Optimizing the RGB value of said UV texture to match said edited 2D image on said masked region.

According to an example, said step of generating said edited diffuse color image comprises rendering said edited diffuse UV texture into an edited diffuse color image.

According to an example, said acquiring module comprises at least one optical unit configured to capture at least a plurality of images of said object.

According to an example, said 3D mesh generating module is configured to reconstruct said 3D mesh from said first plurality of view dependent images.

In the context of the present technology, “Texture” may refer to a digital representation, designed to visually replicate the appearance a real-world surface or material in a virtual environment. A texture can comprise patterns, colors, and surfaces digitally mapped onto a 3-dimensional (3D) virtual object, enhancing the object's aesthetic and realistic attributes.

In the context of the present technology, “consistent texture” may refer to a digital representation or construction of an aesthetic presentation detail that maintains or exhibits coherence, uniformity, stability, or continuity across the surface of a 3D object. This consistency enables the texture to be uniformly applied, manipulated, or mapped onto any part or the entire surface of a 3D object, while retaining its stylistic and visual properties. It comprises aspects of the texture's fundamental characteristics such as color, roughness, smoothness, reflectivity, transparency, and other digital or physical attributes that it may represent, which remain invariant or harmonized in the presence of operations such as rotation, resizing, distortion, lighting changes, or other transformations that the 3D object undergoes. “Consistent texture” may include, but is not limited to, algorithmically derived patterns, synthetic textures, or real-world inspired textures that are digitally captured and processed for applicability on the 3D object in a consistent manner.

In the context of the present technology, “3D texture” or “UV texture” may refer to a two-dimensional image assigned on to the surface of a three-dimensional object via UV coordinate system. The term “UV” designates the axes of the 2D image, which can be imagined as a Cartesian plane, whereas, the 3D object or model is typically set within an XYZ Cartesian coordinate system. The UV mapping process involves the point-by-point alignment of each specific point in the 2D texture to corresponding points in the 3D object's surface. The UV texture represents a textured representation on a 3D object surface through computational algorithms which convert the 3D spatial coordinates into the 2D ‘UV’ texture space. This process can enable realistic rendering, simulation, and visualization of 3D models in digital environments, such as in video games, animation, virtual reality, etc.

In the context of the present technology, “UV base texture” may refer toa global view-invariant diffuse texture. Basically, it is an image in UV space with three channels of RGB values.

In the context of the present technology, “UV coordinate” may refer to any pixel in UV space. For each pixel in UV space, it will map to a 3D location with a pre-computed UV-atlas for a 3D mesh.

In the context of the present technology, “UV direction” may refer to to camera direction. “UV direction” can be also called “camera direction”.

In the context of the present technology, “structure-aware UV texture” may refer to a UV texture which is sensitive and adaptive to the inherent geometric or structural properties of a 3D object. This implying that the texture mapping approach takes into account the structural characteristics of the 3D model. It may include orientation of surfaces, edges, corners, curvature, among others. This allows for a more realistic and effective texturing that is cognizant of the shape, curvature, edges, and other geometrical features of the 3D object. It provides more accurate behavior of texturing, especially when the texture needs to flow accurately over complex structures, and hence improves overall visual appearance and realism.

In the context of the present technology, “3D digital content” may refer to any material, such as data or information, created and existing in a three-dimensional digital environment. This content can include 3D models, animations, virtual elements, and any other digital objects that have been coded or structured to exist in three spatial dimensions—height, width, and depth. These objects are typically used in different industries such as gaming, film production, architecture, 3D printing, virtual reality, augmented reality, and others. They can be rotated and viewed from different angles, providing a lifelike, immersive experience for users.

In the context of the present technology, “3D mesh” may refer to a type of digital representation applied in the field of 3D computer graphics. It encompasses a collection of vertices, edges, and faces that use polygonal representation, such as triangles or quadrilaterals, to define the shape of a 3-dimensional object. A 3D mesh is usually employed when precise detailing and flexibility are required in the model. For example, a “3D Triangle Mesh” is a specific form of a 3D mesh. It contains a set of triangles that are connected by their edges and vertices to form a 3-dimensional object. Each triangle in a 3D triangle mesh is a flat surface, and combined, they can represent more complex shapes. The primary advantage of using a 3D triangle mesh is its simplicity and computational efficiency, as complex polygons can be simplified into numerous smaller triangles. This feature is widely used in computer graphics and computational modeling.

In the context of the present technology, “geometric mapping space” or “UV space” may refer to a UV atlas map together with a UV texture image. For the UV atlas map, it contains the mapping from 3D mesh to UV texture image. Basically, for each vertice on the 3D mesh, it will map to a UV location (x,y) in the UV texture image.

In the context of the present technology, “color image space” or “RGB space” may refer toa regular RGB image. It has three channels, red/green/blue with range [0, 255].

In the context of the present technology, “depth image” may refer to a kind of graphic representation, where each pixel in the image corresponds not to colors or light intensity, but to a distance or depth from a camera. A depth image portrays an estimation of the distance from a camera or sensor to points in the scene. It is typically represented in a greyscale format, where lighter pixels indicate closer objects and darker pixels represent further ones. Depth images are crucial in fields like robotics, 3D reconstruction, object detection, augmented reality and computer vision for accurate spatial understanding of the environment.

In the context of the present technology, “text prompt” may refer to a string of words, phrase, or sentences that instruct or provide a guideline for an AI model, typically one based on natural language processing, to generate a specific output. The AI model uses this input “text prompt” to understand the context and subsequently produce more text, generate an image or perform a certain task related to the input.

In the context of the present technology, “text-driven generation” may refer to a process within AI and machine learning where algorithms are utilized to generate content, such as sentences, images, videos, or full articles, based on provided text inputs. In other words, this technology synthesizes textual data, learns from its structure, semantics and syntax, and creates new, original content. This kind of technology is regularly used in chatbots, content creation tools, language translation, and various other fields.

In the context of the present technology, “diffusion model” may refer to a type of model in deep learning, a branch of machine learning that mimics the neural circuits of the human brain to process data. The diffusion model is a probabilistic model that deals with the process and pattern of diffusion, that is, the way in which certain information, trends, or behaviors spread throughout a network over time. In the field of AI and computer vision, the diffusion model can be employed in an extensive range of tasks from image generation to restoring damaged images, and other tasks involving complex patterns or predictive analysis. The underlying mechanism of this model involves the training of a neural network to reverse-engineer a diffusion process from a given end result, predicting the original data's properties. One example of such a diffusion model is named “Stable Diffusion” and this model is well-known by the skilled person (see for example the following publication: “Rombach R, Blattmann A, Lorenz D, et al. High-resolution image synthesis with latent diffusion models[C]//Proceedings of the IEEE/CVF conference on computer vision and pattern recognition. 2022:10684-10695”).

In the context of the present technology, “image classification” may refer to categorization and labeling of different groups of images.

In the context of the present specification, a “server” is a computer program that is running on appropriate hardware and is capable of receiving requests (e.g., from devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “device” is any computer hardware that is capable of running software appropriate to the relevant task at hand. Thus, some (non-limiting) examples of devices include personal computers (desktops, laptops, netbooks, etc.), smartphones, and tablets, as well as network equipment such as routers, switches, and gateways. It should be noted that a device acting as a device in the present context is not precluded from acting as a server to other devices. The use of the expression “a device” does not preclude multiple devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers. It can be said that a database is a logically ordered collection of structured data kept electronically in a computer system

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first module” and “third module” is not intended to imply any particular order, type, chronology, hierarchy or ranking (for example) of/between the module, nor is their use (by itself) intended imply that any “second module” must necessarily exist in any given situation. Further, as is discussed herein in other contexts, reference to a “first” element and a “second” element does not preclude the two elements from being the same actual real-world element. Thus, for example, in some instances, a “first” module and a “second” module may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 illustrates a general overview of a method according to an embodiment of the present invention;

FIG. 2 illustrates a more detailed overview of a method according to an embodiment of the present invention;

FIG. 3 illustrates a reconstruction step of a 3D object based on a plurality of images of said 3D object according to an embodiment of the present invention;

FIG. 4 illustrates a general overview of the matching between a 3D mesh and a view-dependent UV texture according to an embodiment of the present invention;

FIG. 5 illustrates steps of a method according to an embodiment of the present invention;

FIG. 6 illustrates schematically steps of a method according to an embodiment of the present invention;

FIG. 7 illustrates schematically a first and a second multilayer perceptron according to an embodiment of the present invention;

FIG. 8 illustrates schematically an acceleration phase of a method according to an embodiment of the present invention;

FIG. 9 illustrates schematically steps of a method configured to be applied on a video file according to an embodiment of the present invention;

FIG. 10 illustrates an example of a computer-implemented system that may be used to implement any of the methods described herein.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

With these fundamentals in place, we will now consider some non-limiting examples to illustrate various implementations of aspects of the present technology.

According to an embodiment, the present invention relates to method configured to bind a view-dependent neural texture to a 3D mesh to support real-time on-device high fidelity novel view rendering, preferable by editing of a user.

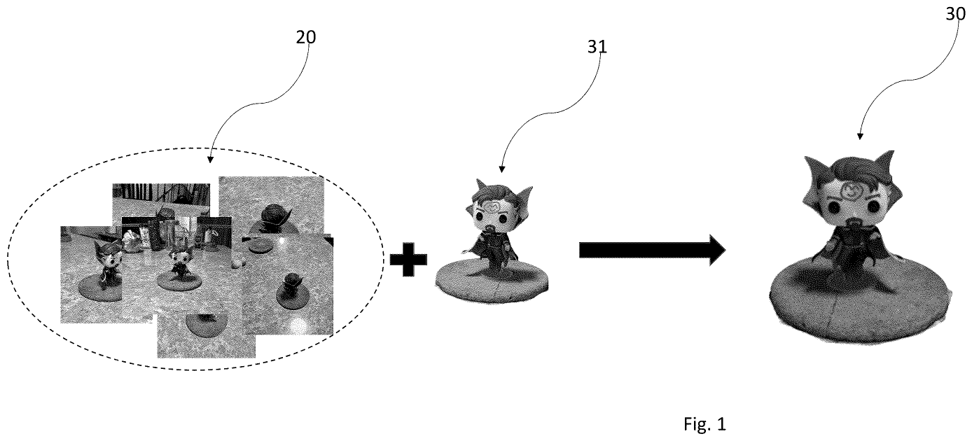

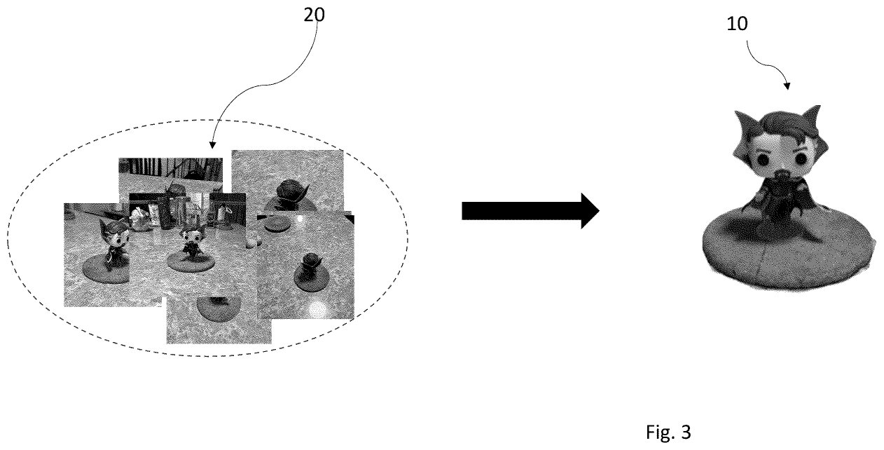

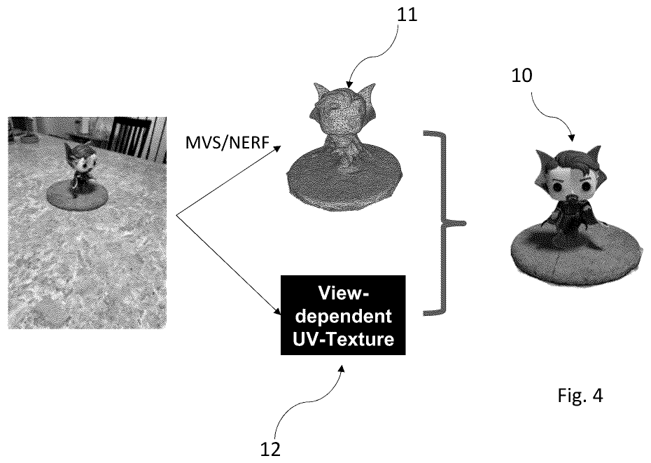

According to an embodiment, and as illustrated by the FIGS. 1 to 4, the input to said method can be a 3D mesh 11, such as a 3D triangle mesh for example. Said 3D mesh 11 can be reconstructed from a plurality of images 20 of an object 10 as illustrated by FIG. 3. According to an embodiment, said 3D mesh 11 could be restored from either NeRF related methods such as NeuS or MVS related methods (see for example the following publication: “Mildenhall et al. NeRF: Representing Scenes as Neural Radiance Fields for View Synthesis, 2020”). According to an embodiment, another input of said invention can comprise captured multi-view images of said object 10.

According to an embodiment, and as illustrated by FIG. 1, the present invention is configured to support interactive texture editing. For example, a user can edit at least one 2D image interactively, and thanks to the present invention, the user editing 31 can be propagated back into 3D texture allowing to generate an edited 3D object 30. Advantageously, the edited part still has the view-dependent effect which is consistent with original input images.

As described hereafter, the present invention can be deployed in real world for 3D model reconstruction and generations applications.

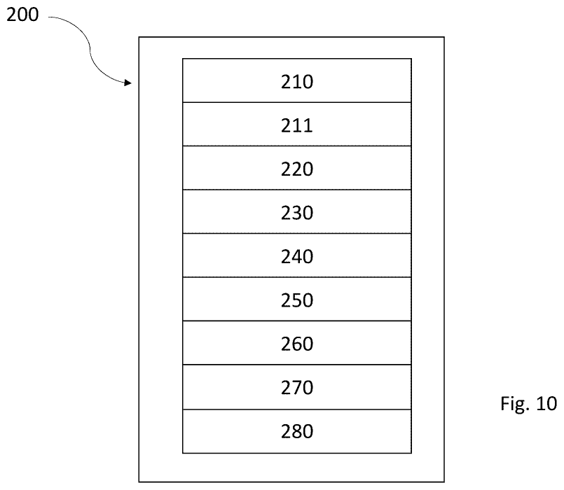

For example, a user can capture multi-view images 20 with his smartphone or other image capturing device 211. Then, with the computer-implement system 200 described hereafter according to an embodiment of the present invention and in FIG. 10, view-dependent textured meshes can be generated. The mesh 11 can be displayed in general laptop or smartphones, and the rendered objects 10 can be viewed in novel views with view-dependent and photo-realistic rendering results.

For another example, a user can edit on any view of a 2D image, and the user scribbles are propagated into 3D texture and rendered it into any novel views, with the view-dependent effects maintained. This feature can be integrated and implemented into 3D texture interactive editing tools, for example.

According to an embodiment, the present invention allows to support real-time on-device rendering of view-dependent textures.

According to an embodiment, and as illustrated by the figures, the present invention relates to method 100 for generating at least one editable 3D texture image. Said method 100 is configured to be executed by at least one computer-implemented system 200 described hereafter.

The present invention opens up an innovative way to edit textures. The present invention allows to edit one of the rendered images and to propagate the editing 31 to the UV texture to synthesize 3D-consistent edited textures 30 from different views. The decomposed view-dependent specular texture can be added back to the textured model.

According to an embodiment, the user can edit an image using a graphical tool and/or a text-to-image generator model configured to convert a prompt such as a sentence into an image or a mark or an editing.

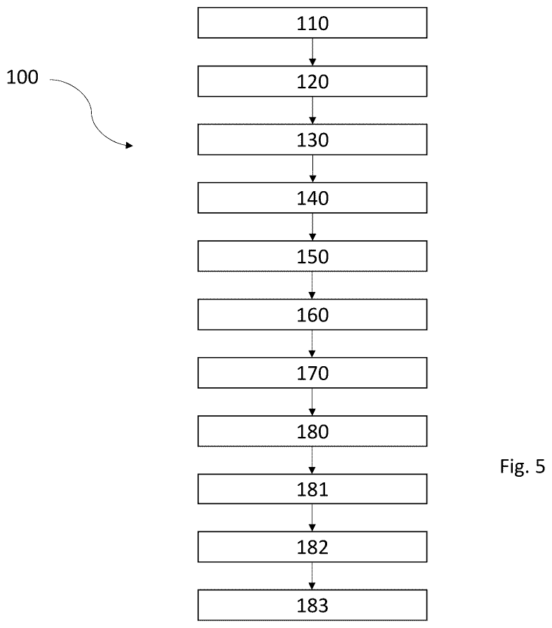

According to an embodiment, and as illustrated by FIG. 5, said method 100 comprises several steps described hereafter.

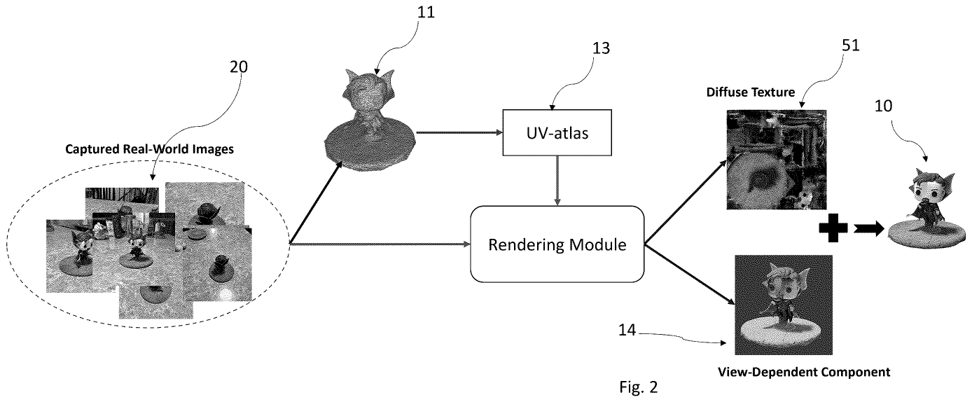

According to an embodiment, and as broadly illustrated by FIGS. 2, 5, 6 and 7, the present invention can comprise a phase, also called decomposition phase. Said method 100 can comprise at least:
Acquiring 110 at least a first plurality of multi-view images 20 of an object 10;
Generating 120 at least a 3D mesh 11 from said first plurality of multi-multi-view images 20; Preferably, said 3D mesh 11 can be reconstructed from said first plurality of multi-view images 20;
Calculating 130 at least one atlas 13, i.e. a UV atlas, from said 3D mesh 11; Said UV atlas 13 comprises UV coordinates 15 which maps vertices on said 3D mesh 11 onto at least one UV image;
Generating 140 at least one diffuse UV texture 41 using a first multilayer perceptron MLPd 40 configured to process said UV coordinates 15;
Generating 150 at least one specular color image 51 using a second multilayer perceptron MLPs 50 configured to process said directions 17;
Generating 160 at least one diffuse color image 52 by rendering said diffuse UV texture 51 combined with said 3D mesh 11;
Rendering 170 at least a 3D texture image by combining at least said specular color image 41 with said diffuse color image 52.
Editing 180, by a user, at least one image of said first plurality of multi-view images 20 and/or at least one image rendered from said 3D texture image;
Propagating 181 said editing onto said diffuse UV texture 41;
Generating 182 an edited diffuse color image by rendering said edited diffuse UV texture combined with said 3D mesh 11;
Rendering 183 an edited 3D texture image by combining said specular color image 51 with said edited diffuse color image.

According to an embodiment, said method 100 can comprises also:
before the step of calculating 130 said atlas 13, editing 180, by at least one user, at least one view dependent image from said first plurality of multi-view images 20; and/or
after the step of rendering said 3D texture image, editing 180, by at least one user, at least one view dependent image from said 3D texture image.

The present invention allows a user to edit at least one image and to propagate this editing 31 to the 3D texture image. The user gets therefore an edited 3D object 30 with an edited texture.

According to an embodiment, the step of editing can be executed after the step of rendering said 3D texture image. In this case, the steps of calculating and of view dependent rendering are executed again.

As well-known by the skilled person (see for example the following publication: “Mildenhall et al. NeRF: Representing Scenes as Neural Radiance Fields for View Synthesis, 2020”), a NeRF model can be easily used and trained for novel view synthesis from a given the captured multi-view images of an object and their respective camera poses, for example obtained by COLMAP (see for example the following publication: “Johannes Lutz Schönberger and Jan-Michael Frahm. Structure-from-motion revisited. In Conference on Computer Vision and Pattern Recognition (CVPR), 2016.”). Nevertheless, NeRF editing poses challenges due to its tightly coupled representations. To address these challenges and facilitate convenient 3D editing, as well as seamless integration into downstream applications, the present invention proposes a solution: decomposing preferably the NeRF representations into a 3D mesh 11 and a view-dependent texture, i.e. view dependent components 14. Specifically, and according to an embodiment, the present invention uses NeuS (see for example the following publication: “Peng Wang, Lingjie Liu, Yuan Liu, Christian Theobalt, Taku Komura, and Wenping Wang. Neus: Learning neural implicit surfaces by volume rendering for multi-view reconstruction. Advances in Neural Information Processing Systems, 34:27171-27183, 2021.”) to reconstruct a triangle mesh 11 of the object 10. And advantageously, the present invention is configured to calculate the UV atlas 13 associated with the mesh 11 using for example XAtlas (see for example the following publication: “Jonathan Young. Xatlas: Mesh parameterization/uv unwrapping library, 2023.”).

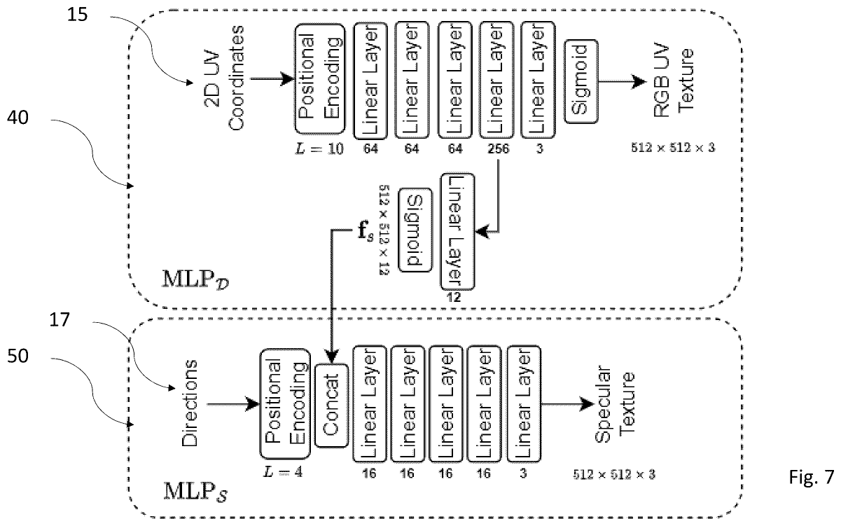

To represent the UV texture 12, the present invention can use at least a first multilayer perceptron MLPd 40 and at least a second multilayer perceptron MLPs 50, as illustrated by FIG. 7. According to an embodiment, said first multilayer perceptron MLPd 40 is configured to represent a global UV feature map and a diffuse texture. According to an embodiment, said second multilayer perceptron MLPs 50 is conditioned on view direction to represent the view-dependent specular texture. Denoting the differentiable mesh rendering by [symbol] , the present invention can formulate the image generation process as follows:

$${c}_{d} , {f}_{S} = sigmoid ( {MPL}_{D} ( v ) ) \qquad ( Eq . 1 )$$

$${c}_{s} = {MLP}_{S} ( {f}_{S} , d ) \qquad ( Eq . 2 )$$

$$c = ℛ ( {c}_{d} + {c}_{S} , ℳ ) \qquad ( Eq . 3 )$$

where v refers to 2D UV coordinates after applying positional encoding, and fₛ are the intermediate features to synthesize the specular color image 51. The features fₛ are forwarded to the view-dependent network MLPs 50 to generate view-dependent effects, conditioned on the view direction d. The final rendered image c is obtained by summing up the diffuse color image c_{d} 42 and the specular color image cₛ 51.

According to an embodiment, the present invention can use a typical reconstruction loss [symbol] (see for example the following publication: “Mildenhall B, Srinivasan P P, Tancik M, et al. Nerf: Representing scenes as neural radiance fields for view synthesis[J]. Communications of the ACM, 2021, 65(1): 99-106.”) to minimize the difference between the rendered image ĉ(x) and its corresponding captured ground truth image c(x) at each pixel x. The loss function can be formulated as follows:

$${ℒ}_{color} = {\sum }_{x} {‖ \hat{c} ( x ) - c ( x ) ‖}^{2} \qquad ( Eq . 4 )$$

In addition, an L1 regularization can be applied to enforce sparsity on the specular color:

$${ℒ}_{specular} = {\sum }_{i} \vert {c}_{S} ( {x}_{i} ) \vert \qquad ( Eq . 5 )$$

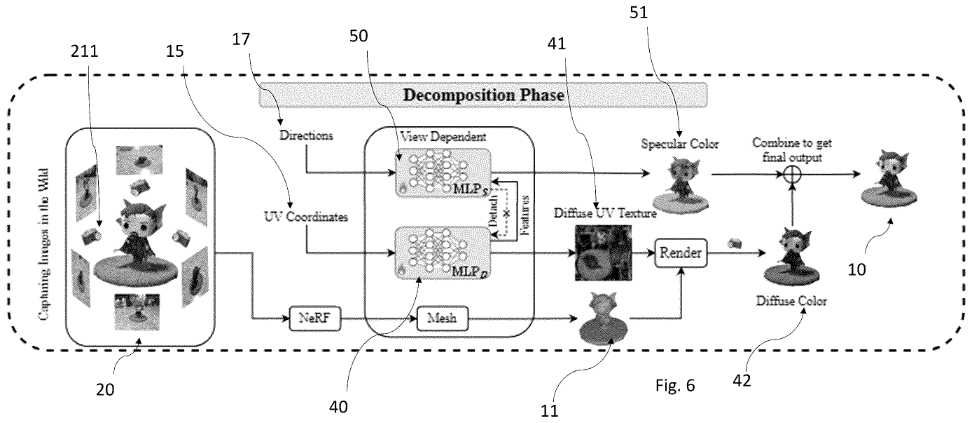

The training of the first multilayer perceptron MLPd 40 and of the second multilayer perceptron MLPs 50 can be achieved with a single-stage framework, as illustrated in FIG. 6. More specifically, the first multilayer perceptron MLPd 40 and of the second multilayer perceptron MLPs 50 can be jointly optimized, where the gradient from the specular branch will only be used to update the second multilayer perceptron MLPs 50, and not be propagated to the first multilayer perceptron MLPd 40. The second multilayer perceptron MLPs 50 is a by-product for decomposing the diffuse and specular textures.

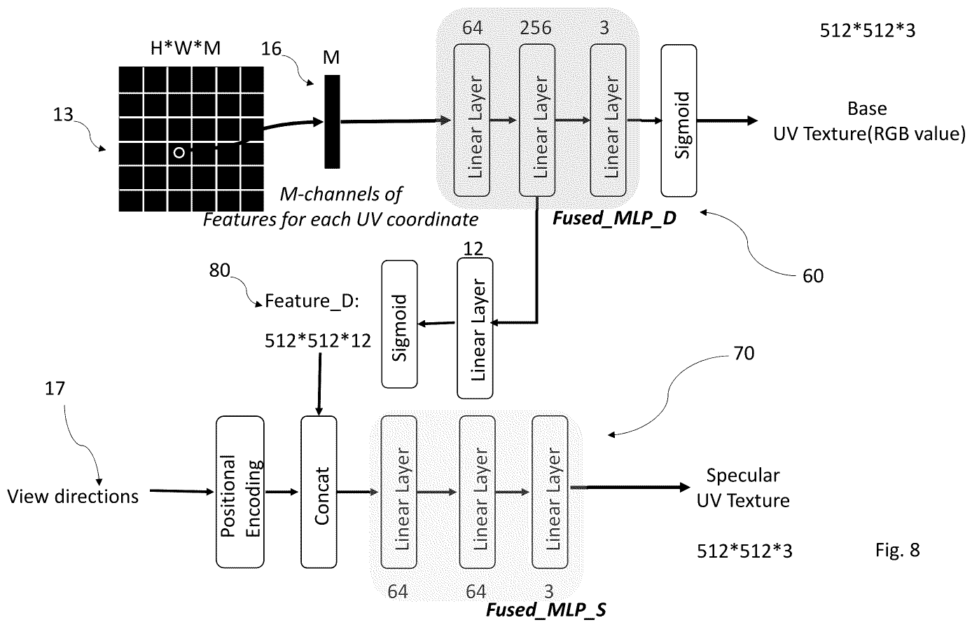

According to an embodiment, and as illustrated by FIG. 8, the present invention can advantageously use instant-ngp (see for example the following publication: “Anish Mittal, Rajiv Soundararajan, and Alan C. Bovik. Making a “completely blind” image quality analyzer. IEEE Signal Processing Letters, 20(3): 209-212, 2013.”) to accelerate the optimization to achieve convergence within only a few minutes, preferably 3 minutes on a single NVIDIA V100 GPU, for example.

Indeed, according to said embodiment, the step of generating 140 at least one diffuse UV texture 41 can comprise:
Encoding of each UV coordinate 15 with a M-Channels 16 of features; Preferably, for each UV coordinate 15, a M-channels 16 of feature is optimized during training. The number M can be equal to 8, for example.
Generating at least one diffuse UV texture 41, also called base UV texture, and at least one feature vector 80 using at least one third multilayer perceptron MLPdf 60 configured to process said features; Said base UV texture 41 being preferably a global view-invariant diffuse texture; said base UV texture 41 being advantageously an image in UV space with three channels of RGB values.

Indeed, according to said embodiment, the step of generating 150 at least one specular color image 51 can comprise:
Generating at least one specular UV texture using at least one fourth multilayer perceptron MLPsf 70 configured to process at least said feature vector 80 and at least one view direction 17; Said specular UV texture being preferably a view dependent texture; Said step of generating at least one specular UV texture can comprise:
   Positional encoding of said view direction 17;
   Concatenating said feature vector with at least said positional encoded view direction;
   Generating said specular UV texture by processing said concatenation by said fourth multilayer perceptron 70.
Converting said specular UV texture into a specular color image 51.

Indeed, according to said embodiment, for each UV coordinate 15, it has a feature to be optimized, called “Feature Enc” for example. Basically, each UV coordinate 15 is encoded with a M-channels 16 of features. Then said feature is input into said third multilayer perceptron MLPdf, called “Fused MLPd” for example, and output a RGB value, corresponding to the base UV texture 41, and also a feature vector 80, called “Feature D” for example. Said feature vector 80 and view direction 17 will input into a fourth multilayer perceptron MLPsf 70, called “Fused MLPs” for example, and output the specular UV texture, i.e. the view-dependent texture residual, preferably comprising 3 rgb channels for each uv location. Finally, the base UV texture and the specular UV texture 51 are combined to be rendered into the image space. The loss is to minimize the predicted image and the captured image, also called the ground-truth RGB image; said captured image being part of said plurality of images 20.

According to an embodiment, the third multilayer perceptron MLPdf 60 and the fourth multilayer perceptron MLPsf 70 comprise each several fully connected layers as well known by the skilled person (see for example the following publication: ““Müller T, Evans A, Schied C, et al. Instant neural graphics primitives with a multiresolution hash encoding[J]. ACM Transactions on Graphics (ToG), 2022, 41(4): 1-15”.). As the present invention can use the so-called Tiny CUDA Neural Network Framework, also called “tiny-cudann”, to implement said network, these third and fourth multilayer perceptron can be called “fused” multilayer perceptron to follow the wording used by the skilled person.

This allows to accelerate the training. Indeed, in the network structure, the first multilayer perceptron MLPd 40 is split into Feature Enc. and said third multilayer perceptron MLPdf 60. Said third and fourth multilayer perceptrons are relatively shallow networks. According to an embodiment, the so called tiny-cudann can be used to accelerate the training.

According to an embodiment, the correspondence between UV coordinates 15 and every image pixel can be pre-computed to reduce the processing time. Then, said mapping can be cached. This allows to calculate this mapping only one time. Preferably, for training, the loss is to minimize the distance L1 between a rendered image from UV texture and the captured ground truth image. The cached mapping stores advantageously the correspondences between UV texture and captured images. So the cached mapping can be used to train the network and since the mapping will not change, it is not necessary to recompute it during every training iteration.

According to an embodiment, said step of acquiring 110 said first plurality of view dependent of said object 10 can comprise capturing a plurality of images 20 of said object 10. According to another embodiment, said step of acquiring 110 said first plurality of view dependent of said object 10 can comprise downloading a plurality of images 20 of said object 10 from at least one database. Said step of acquiring 110 said first plurality of view dependent of said object is configured to be executed by at least one acquiring module 210 of said computer-implemented system 200, preferably said acquiring module 210 comprising at least one optical unit 211.

According to an embodiment, said step of generating 120 said 3D mesh 11 from said first plurality of multi-view images 20 can comprise at least the use of the so-called Learning Neural Implicit Surfaces by Volume Rendering for Multi-view Reconstruction “NeuS” technic. According to another embodiment, said step of generating 120 said 3D mesh 11 can comprise at least the use of transformer-based 3D reconstruction methods to get said 3D mesh 11. Advantageously, the present invention is not limited to any particular mesh reconstruction approach. Said step of generating 120 said 3D mesh 11 is configured to be executed by at least one 3D mesh generating module 220 of said computer-implemented system 200.

According to an embodiment, the step of calculating 130 said atlas 13 from said 3D mesh 11 and/or said first plurality of multi-view images 20 can comprise at least the use of well-known technics such as the use of the so called python library xatlas. Said atlas comprises 2d images wherein each pixel of said 2D images is related to a spatial position associated to said 3D mesh 11. Said step of calculating 130 said atlas 13 from said 3D mesh 11 and/or said first plurality of multi-view images 20 is configured to be executed by at least one processing module 230 of said computer-implemented system 200.

According to an embodiment, the step of generating 140 said diffuse UV texture 41 can comprise processing said 2D UV coordinates 15 using at least said first multilayer perceptron MLPd 40. According to an embodiment, said step of generating 140 said diffuse UV texture 41 can comprise:
Positional encoding of said 2D UV coordinates 15;
Generating said at least said feature fₛ using at least said first multilayer perceptron MLPd 40;
Generating said diffuse UV texture 41 by processing said positional encoded 2D UV coordinates by at least said first multilayer perceptron MLPd 40.

Said step of generating 150 said diffuse UV texture 51 is configured to be executed preferably by at least one first multilayer perceptron module 250 of said computer-implemented system 200.

According to an embodiment, said feature fₛ is configured to synthesize specular color. Preferably, the size of said feature fₛ is equal to 512*512*12. For example, 512*512 is the resolution of the UV image, and each UV pixel has 12 channels of features.

According to an embodiment, the step of generating 150 said specular color image 51 can comprise processing said UV directions 17, i.e. a plurality of camera's directions, i.e. of views directions, using at least said second multilayer perceptron MLPs 50. According to an embodiment, said step of generating 150 said specular color image 51 can comprise:
Positional encoding of said view direction 17;
Concatenating at least said positional encoded view direction with at least said feature fs;
Generating at least one specular UV texture by processing said concatenation by at least said second multilayer perceptron MLPs 50;
Converting said specular UV texture into said specular color image 51.

Said step of generating 150 said specular color image 51 is configured to be executed preferably by at least one second multilayer perceptron module 250 of said computer-implemented system 200.

According to an embodiment, the step of generating 160 said diffuse color image 52 can comprise rendering said diffuse UV texture 41 into a diffuse color image 42, preferably using a rendering engine. Said step of generating 160 said diffuse color image 42 can comprise converting said diffuse UV texture 41 from a UV space into a color space to generate said diffuse color image 42. Said step of generating 160 said diffuse color image 42 is configured to be executed by at least one UV texture generating module 260 of said computer-implemented system 200.

According to an embodiment, the step of rendering 170 said editable 3D texture image can comprise combining said specular image 51 with said diffuse color image 42. Preferably said step of rendering 170 said editable 3D texture image can comprise using a rendering engine to combined said specular image 51 with said diffuse color image 42. Said step of generating 170 said editable 3D texture image is configured to be executed by at least one 3D texture image generating module 270 of said computer-implemented system 200.

According to an embodiment, the step of editing 180 at least one single 2D image, preferably at least one image of said first plurality of multi-view images 20 and/or at least one image from said 3D texture image, can comprise:
Selecting at least said 2D image among a plurality of 2D images, for example among said first plurality of multi-view images 20, and/or among a set of frames.
Modifying locally at least a region of said 2D image, for example by changing the RBG value of a set of points of said region.

Said step of editing 180 is configured to be executed preferably by at least one editing module 280 of said computer-implemented system 200.

According to an embodiment, said step of propagating 181 said editing onto said diffuse UV texture 41 can comprise:
Localizing said edited region in said 2D image as a masked region;
Rendering said UV texture onto corresponding 2D image;
Optimizing the RGB value of said UV texture to match said edited 2D image on said masked region.

Said step of propagating 181 is configured to be executed preferably by at least one editing module 280 of said computer-implemented system 200.

According to an embodiment, the step of generating 182 said edited diffuse color image can comprise rendering said edited diffuse UV texture into an edited diffuse color image, preferably using a rendering engine. Said step of generating 182 said edited diffuse color image can comprise converting said edited diffuse UV texture from a UV space into a color space to generate said edited diffuse color image. Said step of generating 182 said edited diffuse color image is configured to be executed by at least said UV texture generating module 260 of said computer-implemented system 200.

According to an embodiment, the step of rendering 183 said edited 3D texture image can comprise combining said specular image 51 with said edited diffuse color image. Preferably said step of rendering 183 said edited 3D texture image can comprise using a rendering engine to combined said specular image 51 with said edited diffuse color image. Said step of generating 183 said edited 3D texture image is configured to be executed by at least said 3D texture image generating module 270 of said computer-implemented system 200.

The present invention allows a user to edit on single 2D image. Then, the present invention propagates the editing onto the diffuse UV texture; More specifically, the editing is propagated by first localizing the edited region in 2D image as a mask, and then the UV texture is rendered onto the corresponding 2D image and the RGB value of the UV texture is optimized to match the edited 2D image on the masked region. Advantageously, the other parts of the network do not need to change and the view-dependent effects remain in the edited region when rendered in novel views.

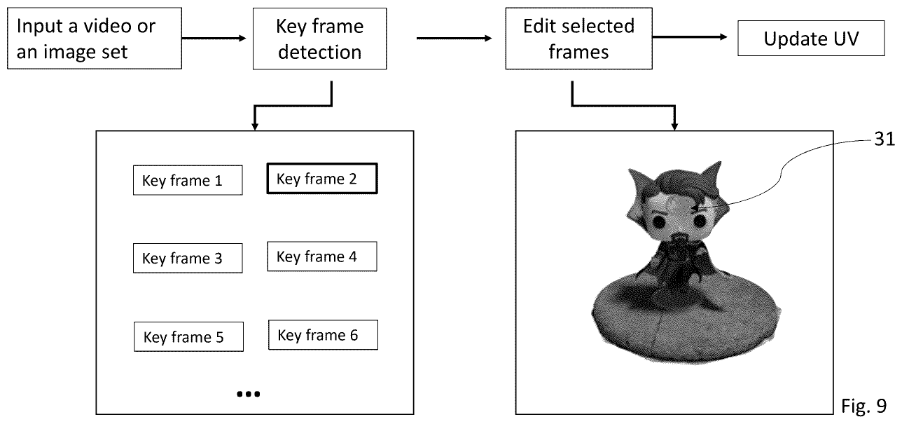

According to an embodiment, and as illustrated in FIG. 9, said plurality of images can come from a video, i.e. a set of frames wherein each frame is an image. According to said embodiment, a user can select a key frame and then edit the frame related to said key frame, then said edited frame is used as an edited image as previously described to generate an edited 3D texture image.

According to an embodiment, and as illustrated in FIG. 10, the present invention relates to a computer-implemented system 200 for generating at least one 3D texture image. Said computer-implemented system 200 is configured to execute the method 100 according to the present invention.

According to an embodiment, said computer-implemented system 200 comprises:
An acquiring module 210 configured to acquire at least a first plurality of multi-view images 20 of an object 10; Said acquiring module 210 can comprise at least one optical unit 211 configured to capture at least a plurality of images of said object;
A 3D mesh generating module 220 configured to generate at least a 3D mesh 11 from said first plurality of multi-view images 20; Preferably, said 3D mesh generating module can be configured to reconstruct said 3D mesh from said first plurality of multi-view images 20;
A processing module 230 configured to calculate at least one atlas 13, i.e. a UV atlas, from said 3D mesh 11 and/or said first plurality of multi-view images 20;
A first multilayer perceptron module 240 configured to generate at least one diffuse UV texture 41 using a first multilayer perceptron MLPd 40 configured to process said UV coordinates;
A second multilayer perceptron module 250 configured to generate at least one specular color image 51 using a second multilayer perceptron MLPs 50 configured to process said directions;
A UV texture generating module 260 configured to generate at least one diffuse color image 42 by rendering said diffuse UV texture 41 combined with said 3D mesh 11;
A 3D texture image generating module 270 configured to render 170 at least a 3D texture image by combining at least said specular color image 51 with said diffuse color image 42;
An editing module 280 configured to allow at least one user to edit at least one image from said first plurality of multi-view images 20 and/or at least one image rendered from said 3D texture image.

According to an embodiment, said computer-implemented system 200 is configured to execute at least a plurality of instructions, preferably stored in a non-volatile storage device; these instructions are configured to execute the method 100 according to the present invention when they are executed by at least one processor of said computer-implemented system 200.

According to an embodiment, said computer-implemented system 200 can comprise a computer or any electronic device similar to a computer. Optionally, said computer-implemented system 200 can be coupled with a communication network, for example by way of two-way communication lines. Said computer-implemented system 200 can comprise a user interface, for example a keyboard, a mouse, voice recognition capabilities or other interface permitting the user to access and provide input to computer-implemented system. Said computer-implemented system 200 can comprise at least one monitor. Said computer-implemented system 200 can comprise a CPU. Said computer-implemented system 200 can be a desktop computer or a laptop computer, for example, or even a web server. According to an embodiment, said computer-implemented system 200 can comprise at least one optical unit. Said Optical unit can be configured to capture, i.e. to acquire, at least one image, preferably a plurality of images. Said image can be a prompt. Said plurality of images can be used to generate a 3D object and a view-dependent texture.

According to an embodiment, the present invention relates to an editable view-dependent rendering engine comprising at least one computer-implemented system 200 configured to implement said method 100.

Unless otherwise specified herein, or unless the context clearly dictates otherwise the term about modifying a numerical quantity means plus or minus ten percent. Unless otherwise specified, or unless the context dictates otherwise, between two numerical values is to be read as between and including the two numerical values.

In the present description, some specific details are included to provide an understanding of various disclosed implementations. The skilled person in the relevant art, however, will recognize that implementations may be practiced without one or more of these specific details, parts of a method, components, materials, etc. In some instances, well-known methods associated with artificial intelligence, machine learning and/or neural networks, have not been shown or described in detail to avoid unnecessarily obscuring descriptions of the disclosed implementations.

In the present description and appended claims “a”, “an”, “one”, or “another” applied to “embodiment”, “example”, or “implementation” is used in the sense that a particular referent feature, structure, or characteristic described in connection with the embodiment, example, or implementation is included in at least one embodiment, example, or implementation. Thus, phrases like “in one embodiment”, “in an embodiment”, or “another embodiment” are not necessarily all referring to the same embodiment. Furthermore, the particular features, structures, or characteristics may be combined in any suitable manner in one or more embodiments, examples, or implementations.

As used in this description and the appended claims, the singular forms of articles, such as “a”, “an”, and “the”, can include plural referents unless the context mandates otherwise. Unless the context requires otherwise, throughout this description and appended claims, the word “comprise” and variations thereof, such as, “comprises” and “comprising” are to be interpreted in an open, inclusive sense, that is, as “including, but not limited to”.

All scientific publications referred to in this description, are incorporated by reference in their entireties for all purposes herein.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

### REFERENCES

10 3D object
11 3D mesh
12 UV texture
13 UV atlas
14 View-dependent components
15 UV coordinate
16 M-Channels
17 View direction
20 Plurality of multi-view images
30 Edited 3D Object
31 Editing
40 First multilayer perceptron MLPd
41 Diffuse UV texture
42 Diffuse color image
50 Second multilayer perceptron MLPs
51 Specular color image
60 Third multilayer perceptron MLPsd
70 Fourth multilayer perceptron MLPdf
80 Feature vector
100 Method for generating an edited 3D texture image
110 Acquiring at least a first plurality of view dependent images of an object
120 Generating at least a 3D mesh of said object from said first plurality of view dependent images
130 Calculating at least one UV atlas from said 3D mesh and/or said first plurality of view dependent images
140 Generating at least at least one diffuse UV texture using a second multilayer perceptron MLPd configured to process said UV coordinates
150 Generating one specular color image using a first multilayer perceptron MLPs configured to process said directions
160 Generating at least one diffuse color image by rendering said diffuse UV texture combined with said 3D mesh
170 Rendering at least a 3D texture image by combining at least said specular color image with said diffuse color image
180 Editing at least one view dependent image from said first plurality of view dependent images
181 Propagating said editing onto said diffuse UV texture
182 Generating an edited diffuse color image by rendering said edited diffuse UV texture combined with said 3D mesh
183 Rendering an edited 3D texture image by combining said specular color image with said edited diffuse color image
200 Computer-implemented system
210 Acquiring module
211 Optical unit
220 3D mesh generating module
230 Processing module
240 First multilayer perceptron module
250 Second multilayer perceptron module
260 UV texture generating module
270 3D texture image generating module
280 Editing module

1. A method for generating at least one edited 3D texture image, said method being configured to be executed by at least one computer-implemented system, said method comprising:
acquiring a first plurality of multi-view images of an object;
generating a 3D mesh of said object from said first plurality of multi-view images;
calculating a UV atlas from said 3D mesh, said UV atlas comprising UV coordinates which maps vertices on said 3D mesh onto at least one UV image;
generating:
a diffuse UV texture using a first multilayer perceptron MLPd configured to process said UV coordinates; and
a specular color image using a second multilayer perceptron MLPs configured to process said directions;
generating a diffuse color image by rendering said diffuse UV texture combined with said 3D mesh;
rendering a 3D texture image by combining said specular color image with said diffuse color image;
editing, by a user, at least one image of said first plurality of multi-view images and/or at least one image rendered from said 3D texture image;
propagating said editing onto said diffuse UV texture;
generating an edited diffuse color image by rendering said edited diffuse UV texture combined with said 3D mesh; and
rendering an edited 3D texture image by combining said specular color image with said edited diffuse color image.

2. The method of claim 1, wherein said representation of said 3D object is reconstructed from at least a plurality of images of an object.

3. The method of claim 1, wherein said 3D mesh is a 3D triangle mesh.

4. The method of claim 1, wherein a correspondence between UV image and every image pixel of said UV texture image is pre-computed to generate at least one mapping, said mapping being cached in at least one memory.

5. The method of claim 1, wherein said step of acquiring said first plurality of view dependent of said object comprises:
capturing a plurality of images of said object; and/or
downloading a plurality of images of said object from at least one database.

6. The method of claim 1, wherein said step of generating said diffuse UV texture comprises:
positional encoding of said 2D UV coordinates;
generating at least one feature fₛ using at least said first multilayer perceptron MLPd, said feature fₛ being configured to be used to generate said specular color image;
generating said diffuse UV texture by processing said positional encoded 2D UV coordinates by at least said first multilayer perceptron MLPd.

7. The method of claim 6, wherein said step of generating said specular color image comprises:
positional encoding of said view direction;
concatenating at least said positional encoded view direction with at least said feature fₛ;
generating at least one specular UV texture by processing said concatenation by at least said second multilayer perceptron MLPs;
converting said specular UV texture into a specular color image.

8. The method of claim 1, wherein said step of generating at least one diffuse UV texture comprises:
encoding of each UV coordinate with at least a predetermined number of channels of features;
generating at least one diffuse UV texture and at least one feature vector using at least one third multilayer perceptron MLPdf configured to process said features.

9. The method of claim 8, wherein said step of generating at least one specular color image comprises:
positional encoding of said view direction;
concatenating said feature vector with at least said positional encoded view direction;
generating said specular UV texture by processing said concatenation by at least a fourth multilayer perceptron MLPsf;
converting said specular UV texture into said specular color image.

10. The method of claim 1, wherein said step of generating said diffuse color image comprises rendering said diffuse UV texture into a diffuse color image.

11. The method of claim 10, wherein said step of generating said diffuse color image comprises converting said diffuse UV texture from a UV space into a color space to generate said diffuse color image.

12. The method of claim 11, wherein said step of editing comprises:
selecting at least one 2D image among said first plurality of multi-view images and/or at least one 2D image from said 3D texture image;
modifying locally at least a region of said 2D image, for example by changing the RBG value of a set of points of said region.

13. The method of claim 12, wherein said step of propagating said editing onto said diffuse UV texture comprises:
localizing said edited region in said 2D image as a masked region;
rendering said UV texture onto corresponding 2D image;
optimizing the RGB value of said UV texture to match said edited 2D image on said masked region.

14. The method of claim 13, wherein the step of generating said edited diffuse color image comprises rendering said edited diffuse UV texture into an edited diffuse color image.

15. A computer product program generating at least one 3D texture image which, when executed by at least one computer-implemented system, executes the method according to claim 1.

16. A computer-implemented system for generating at least one 3D texture image comprising at least:
an acquiring module configured to acquire at least a first plurality of multi-view images of an object;
a 3D mesh generating module configured to generate at least a 3D mesh from said first plurality of multi-view images;
a processing module configured to calculate at least one atlas from said 3D mesh;
a first multilayer perceptron module configured to generate at least one specular color image using a first multilayer perceptron MLPs configured to process said directions;
a second multilayer perceptron module configured to generate at least one diffuse UV texture using a second multilayer perceptron MLPd configured to process said UV coordinates;
a UV texture generating module configured to generate at least one diffuse color image by rendering said diffuse UV texture combined with said 3D mesh;
a 3D texture image generating module configured to render at least a 3D texture image by combining at least said specular color image with said diffuse color image;
an editing module configured to allow at least one user to edit at least one image from said first plurality of multi-view images and/or at least one image rendered from said 3D texture image.

17. The computer-implemented system of claim 16, wherein said acquiring module comprises at least one optical unit configured to capture at least a plurality of images of said object.

18. The computer-implemented system of claim 16, wherein said 3D mesh generating module is configured to reconstruct said 3D mesh from said first plurality of view dependent images.
